(19) United States
(12) Patent Application Publication
(10) Pub. No.: US 2003/0133759 A1
(43) Pub. Date: Jul. 17, 2003

(54) Agricultural machine

(76) Inventor: Henrik Winther, Mjolby (SE)

Correspondence Address: Nixon & Vanderhye, 8th Floor, 1100 North Glebe Road, Arlington, VA, 22201-4714, US

(21) Appl. No.: 10/257,136

(22) PCT Filed: Apr. 11, 2001
(86) PCT No.: PCT/SE01/00814

(30) Foreign Application Priority Data
Apr. 11, 2000 (SE) 0001349-0
Oct. 20, 2000 (SE) 0003814-1

(51) Int. Cl. B65G 53/38

(52) U.S. Cl. 406/138

(57) ABSTRACT

An arrangement for spreading material, comprising at least one container (1) for holding the material (6) and having a conveyor duct (2), which is connected to the container (1) and is designed to accommodate an air flow for conveying the material (6) from the container (1) to at least one dispensing element (12). The conveyor duct (2) is provided with a venturi-like constriction (18) and the container (1) is connected to the conveyor duct (2) by the said constriction (18), so that the material (6) is fed from the container (1) to the conveyor duct (2) by means of the venturi effect.

The present invention relates to an arrangement for spreading material, comprising at least one container for holding the material and a conveyor duct connected to the container and designed to accommodate a flow of air for conveying the material from the container to at least one dispensing element.

Such an arrangement is used, among other things, in sowing machines for sowing seed, fertilizer or the like in the ground. The material is distributed to implements arranged in the sowing machine, such as sowing shares, which are arranged so that the material is taken down into the ground. Such arrangements are also used on other types of machines, such as salt spreaders for distributing road salt.

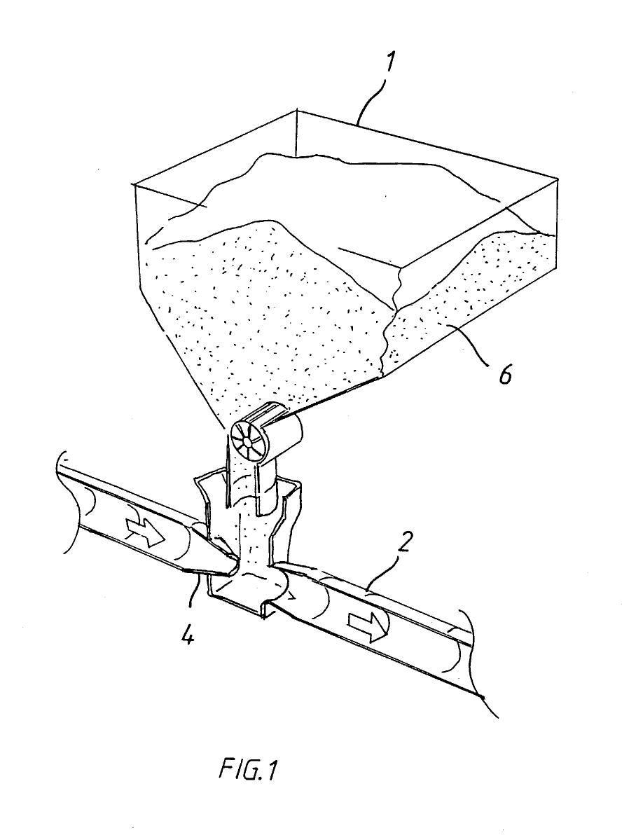

There is a known type of sowing machine, which is provided with an open container and with a conveyor duct, which conveys the material to the implements. An ejector is arranged in the conveyor duct in order to feed material from the container to the conveyor duct. The ejector contributes to a loss of power, however, so that it becomes uneconomic to build a large machine equipped with such a system. The advantage to this known type of sowing machine is that it has a low weight and that the container is open, which facilitates filling and cleaning of the container. Such a known system is shown in FIG. 1.

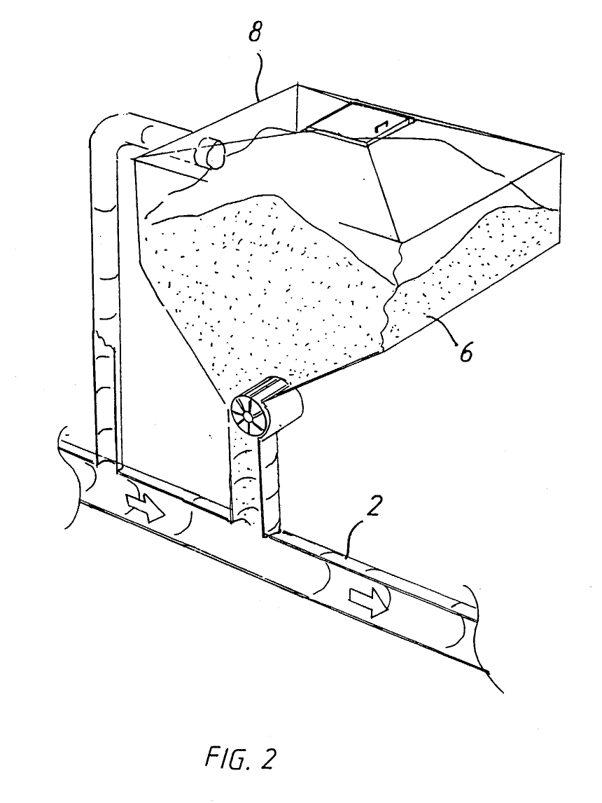

In order to eliminate the ejector there are sowing machines in which an excess pressure prevails in the container in which seed is stored. The excess pressure in the container also means that an excess pressure and high rate of flow can be used in the conveyor duct. This means that such machines can be designed for a large sowing capacity, since ducts and hoses to the various implements can be designed with substantial lengths. The disadvantage with this known system is that the pressurized components in the sowing machine must have dimensions designed to withstand the high pressure, which results in expensive and heavy machines. For the same reasons the container is designed with a small filling hatch, which is provided with seals. The small filling hatch makes filling of the container and cleaning the inside of the container more difficult. Since the system functions with excess pressure, a leakage in the system can lead to breakdowns. A known system of this type is shown in FIG. 2.

The object of the present invention is to produce an arrangement for spreading material, which affords greater efficiency than the known arrangements provided with ejectors.

A further object of the invention is to produce an arrangement for spreading material, which can spread large quantities of material per unit time.

Yet another object of the invention is to produce an arrangement for spreading material, in which the quantity of material spread can be adjusted.

Yet another object of the invention is to produce an arrangement for spreading material, in which the quantity of material spread can be dosed very accurately.

Yet another object of the invention is to produce an arrangement for spreading material, in which materials of different type can be spread simultaneously.

Yet another object of the invention is to produce an arrangement for spreading material, in which materials of different type can be spread with one and the same arrangement.

This is achieved with an arrangement of the type indicated in the introductory part, in which the conveyor duct is provided with a venturi-like constriction and that the container is connected to the conveyor duct by the said constriction, so that the material is fed from the container to the conveyor duct by means of the venturi effect.

By feeding the material from the container to the conveyor duct by means of a venturi-like constriction arranged in the conveyor duct, large quantities of material can be spread very efficiently. The venturi-like constriction means the container can be designed to function without excess pressure. This means that the container can be designed with a large filling hatch, which facilitates filling and cleaning of the container.

According to one embodiment of the invention the arrangement can be adapted to an agricultural machine, in which the material consists of seed, fertilizer or the like and in which each dispensing element comprises an implement for delivering the material to the ground. Since no excess pressure need prevail in the container in which the material is stored, the container and hence the entire agricultural machine can be designed with a low weight. Such a sewing machine can also be designed for a large sowing capacity, since the air flow in ducts and hoses to the various implements allows the ducts and hoses to be designed with considerable lengths.

According to a second embodiment of the invention the arrangement is provided with a feed unit, which comprises a first and second screw conveyor, which are arranged essentially parallel to one another. With such a configuration material of different types can be spread with one and the same arrangement.

The invention will be explained in more detail below with reference to embodiments shown in drawings attached, in which

FIG. 1 shows a known arrangement for spreading material provided with an ejector,

FIG. 2 shows a known arrangement for spreading material provided with an excess pressure container,

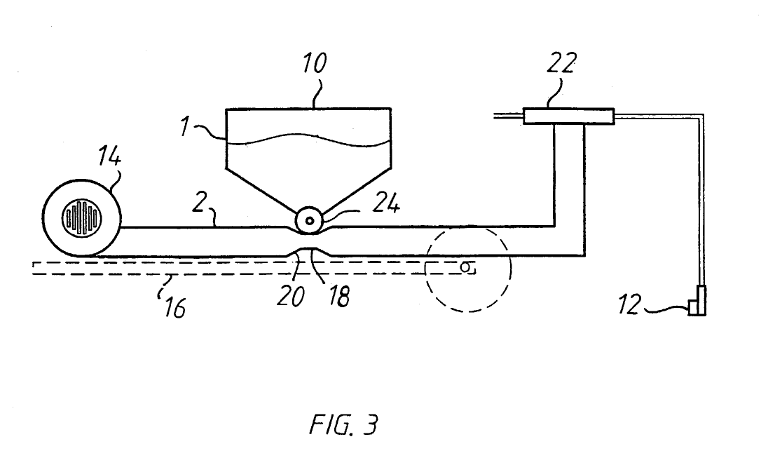

FIG. 3 shows an arrangement for spreading material according to a first embodiment of the present invention,

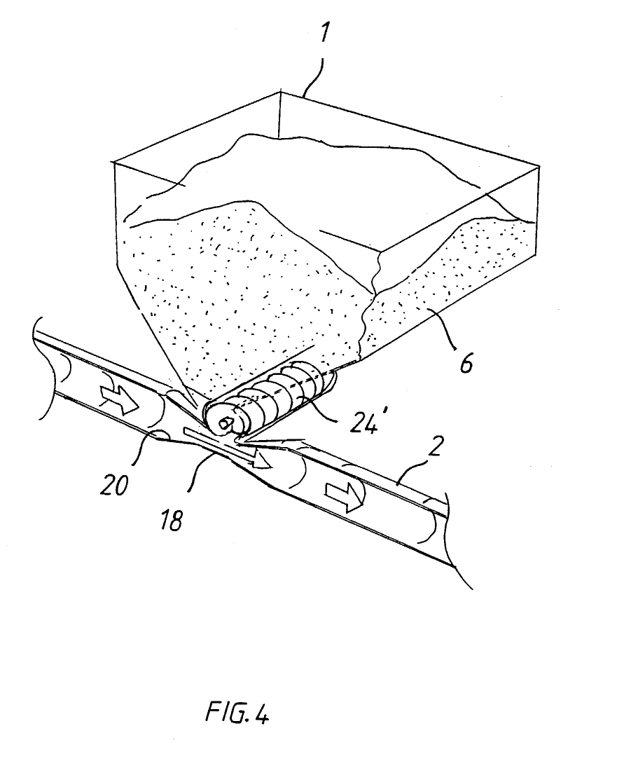

FIG. 4 shows a detailed perspective view of a feed unit according to the invention,

FIG. 5 shows a detailed perspective view of an alternative embodiment of a feed unit according to the invention,

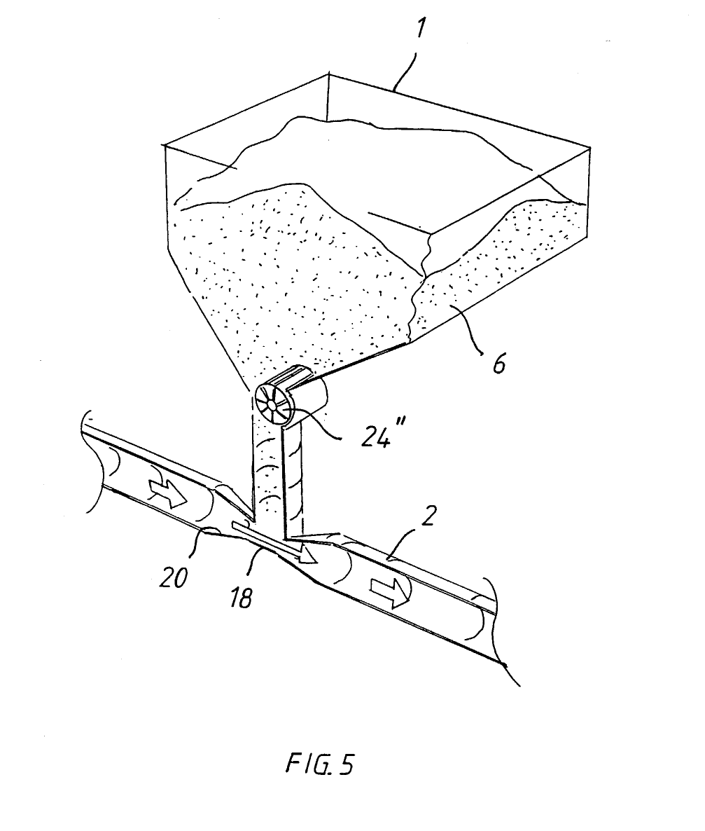

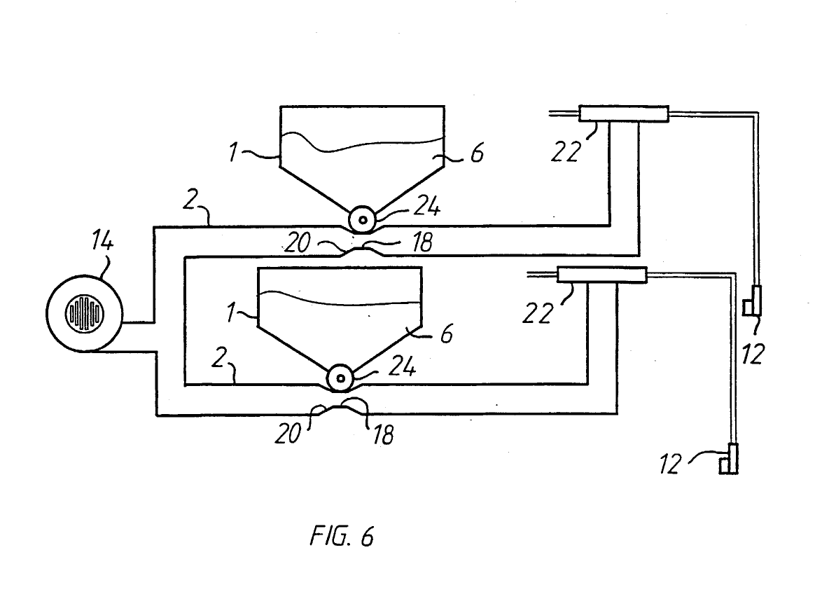

FIG. 6 shows an arrangement for spreading material according to a second embodiment of the present invention,

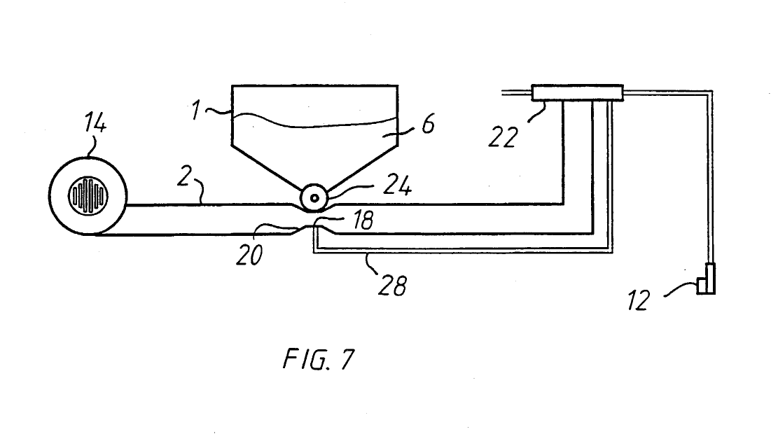

FIG. 7 shows an arrangement for spreading material according to a third embodiment of the present invention,

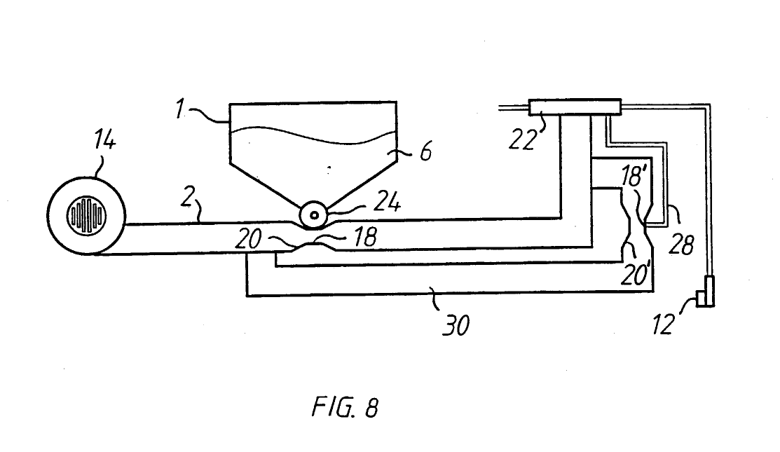

FIG. 8 shows an arrangement for spreading material according to a fourth embodiment of the present invention,

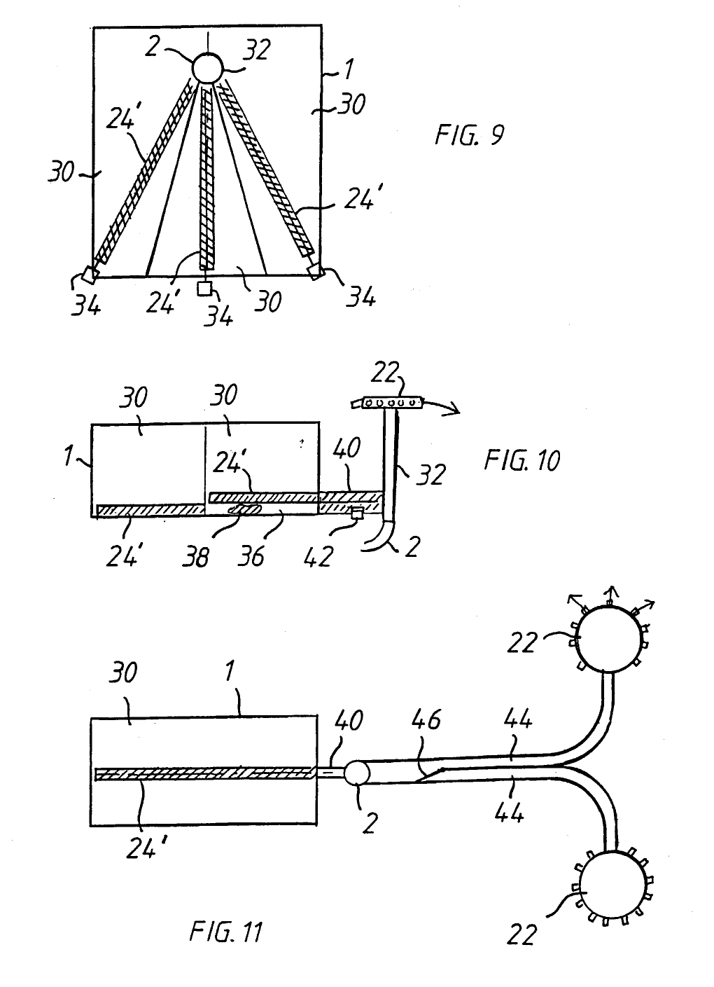

FIG. 9 shows an arrangement for spreading material according to a fifth embodiment of the present invention,

FIG. 10 shows an arrangement for spreading material according to a sixth embodiment of the present invention,

FIG. 11 shows an arrangement for spreading material according to a seventh embodiment of the present invention,

FIG. 12 shows an arrangement for spreading material according to an eighth embodiment of the present invention,

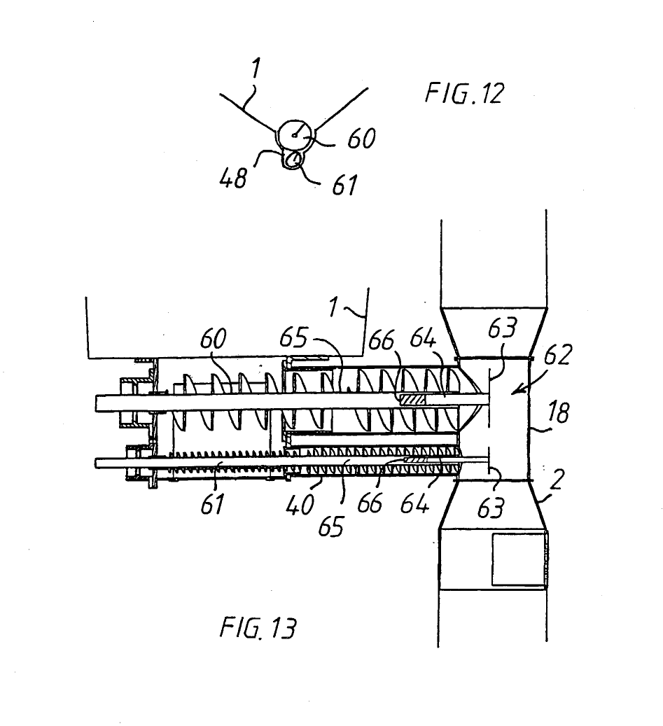

FIG. 13 shows an arrangement for spreading material according to the eighth embodiment of the present invention,

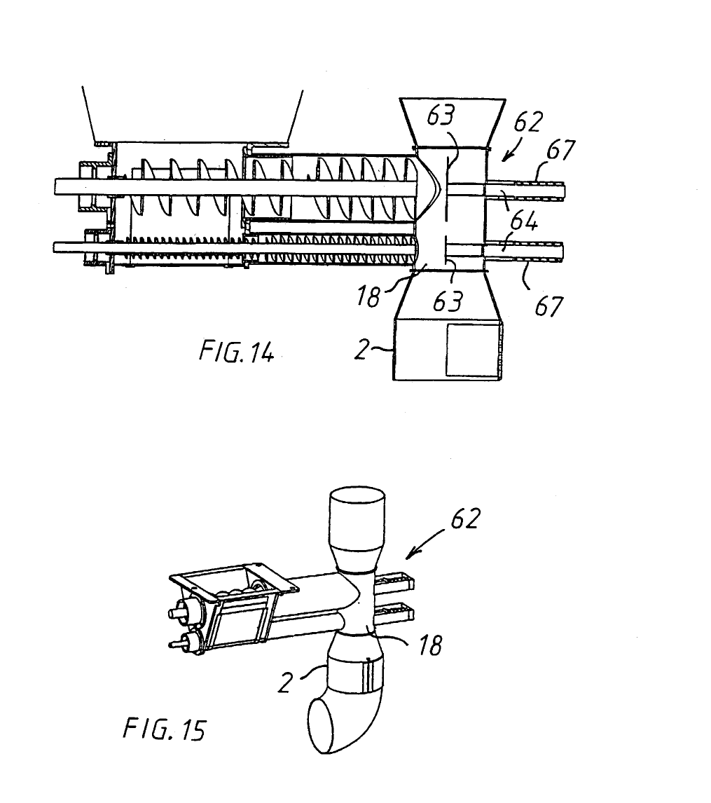

FIG. 14 shows an arrangement for spreading material according to a ninth embodiment of the present invention,

FIG. 15 shows a perspective view of an arrangement for spreading material according to the ninth embodiment,

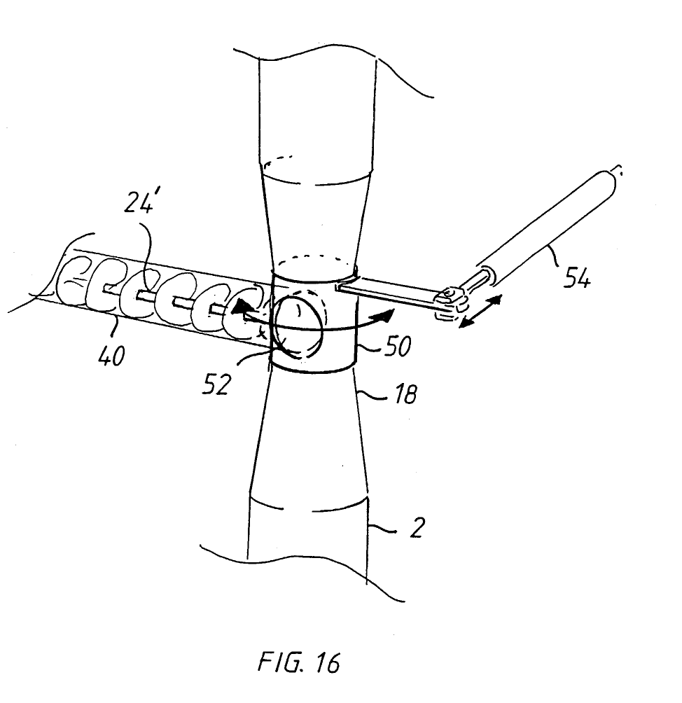

FIG. 16 shows an arrangement for spreading material according to a tenth embodiment of the present invention,

FIG. 1 shows a known arrangement for spreading material. The arrangement is provided with an open container 1 and with a conveyor duct 2, which conveys the material to the feed element (not shown). An ejector 4 for feeding material 6 from the container 1 to the conveyor duct 2 is arranged in the conveyor duct 2. The ejector 4, however, contributes to a power loss, for which reason the disadvantages stated in the introductory part of the description occur with this known type of arrangement.

FIG. 2 shows another known arrangement for spreading material, which is provided with an excess pressure container 8. The excess pressure in the container 8 means that an excess pressure and high rate of flow can be used in the conveyor duct 2. This means that sowing machines of this type can be designed for a large sowing capacity, since ducts and hoses to various dispensing elements can be designed with considerable lengths. The disadvantage with this known arrangement is mentioned in the introductory part of the description.

FIG. 3 shows an arrangement for spreading material 6 according to a first embodiment of the present invention. The arrangement comprises a container 1 for holding the material 6, the container 1 being provided at the top with a filling hatch 10, which may be covered, for example, by a tarpaulin or a cover (not shown). Atmospheric pressure prevails in the container 1, which is achieved in that the inside of the container 1 has a connection to the surrounding atmosphere. A conveyor duct 2 connected to the container 1 is designed to accommodate an air flow for conveying the material 6 from the container 1 to at least one dispensing element 12. The air flow is suitably generated by means of a blower 14 connected to the conveyor duct 2. According to the embodiment shown, the arrangement is adapted to an agricultural machine 16, such as a sowing machine, in which the material 6 consists of seed, fertilizer or the like and in which each dispensing element 12 comprises an implement 12 for delivering the material 6 to the ground. The implements 12 may be sowing shares, for example, which produce a furrow in the ground.

The conveyor duct 2 is provided with a venturi-like constriction 18 and the container 1 is connected to the conveyor duct 2 by the said constriction 18, so that the material 6 is fed from the container 1 to the conveyor duct 2 by means of the venturi effect occurring in the venturi-like constriction 18. According to the exemplary embodiment shown the venturi-like constriction 18 is formed by a venturi tube 20. The venturi-like constriction 18 may also be formed in a curved section of the conveyor duct 2. Downstream of the venturi tube 20, the conveyor duct 2 opens into a distributing element 22, which distributes the material 6 to each implement 12. The venturi effect increases the rate of flow at the constriction 18 of the venturi tube 20, which leads to an increase in the kinetic energy of the air flowing through the venturi tube 20. This in turn leads to an increase in the static pressure at the constriction 18. By designing the arrangement so that the static pressure at the constriction 18 of the venturi tube 20 is lower than the atmospheric pressure, material 6 will be sucked from the container 1 into the venturi tube 20 and then conveyed by the air flow into the conveyor duct 2.

A feed unit 24 is arranged between the container 1 and the conveyor duct 2, the feed unit 24 feeding the material 6 towards the venturi tube 20 in the conveyor duct 2. The feed unit 24 is designed as a dosing unit in order to feed a predetermined quantity of material 6 from the container 1. The feed unit 24 is adjustable so that the predetermined quantity of material 6 can be adjusted.

FIG. 4 shows a detailed perspective view of a feed unit 24 according to the invention, the feed unit 24 comprising a rotary screw 24′. By selecting a suitable pitch for the screw 24′, a predetermined quantity of material can be fed from the container 1 to the conveyor duct 2. By varying the rotational speed of the screw 24′ it is possible to adjust the predetermined quantity of material 6 that is to be fed. By means of such a rotary screw 24′ it is possible to feed large quantities of material per unit time. When the material 6 is being fed by the screw 24′, the relatively low static pressure in the venturi tube 20 will suck the material into the conveyor duct 2. The material 6 is then conveyed to the dispensing elements 12.

FIG. 5 shows a detailed perspective view of an alternative embodiment of a feed unit 24 according to the invention. According to this alternative embodiment the feed unit 24 is designed as a rotary drum 24″, which is provided around its axis of rotation with a plurality of compartments 26, which feed the material 6 towards the conveyor duct 2. By varying the rotational speed of the drum 24″ and/or the size of the compartments 26 it is possible to adjust the predetermined quantity of material 6 that is to be fed.

FIG. 6 shows an arrangement for spreading material 6 according to a second embodiment of the present invention. According to this second embodiment two conveyor ducts 2 are adapted to convey the material 6. Each conveyor duct 2 is provided with a venturi tube 20 and a container 1 is connected to each conveyor duct 2 by the venturi tube 20 of each conveyor duct 2. With such an arrangement different types of material can be spread simultaneously. For example, seed can be held in the one container 1 and fertilizer in granulate form can be held in the other container 1. It is also possible to arrange more than two conveyor ducts 2 and containers 1 for conveying the material 6.

FIG. 7 shows an arrangement for spreading material 6 according to a third embodiment of the present invention. Extending from the distributing element 22 is a return duct 28 for returning a proportion of the material 6 to the air flow in the conveyor duct 2. The return duct 28 is connected to the conveyor duct 2 by the venturi tube 20 arranged in the conveyor duct 2. A plurality of return ducts 2 preferably extend from the distributing element 22 to the conveyor duct 2. Such return ducts 28 are, among other things, appropriate if the connection to one or more implements 12 is shut off in order to produce track marks in the sown field. In order to prevent the distributing element 22 from distributing an increased quantity of the material 6 to the implements 12 unaffected by the shut-off, the material destined for the implements 12 that have been shut off is returned to the conveyor duct 2.

FIG. 8 shows an arrangement for spreading material according to a fourth embodiment of the present invention. A secondary duct 30 is connected to the conveyor duct 2 for diverting a part of the air flow in the conveyor duct 2 to the secondary duct 30 and then returning this part of the air flow to the conveyor duct 2. According to this embodiment the return duct 28 is connected to the secondary duct 30 by a venturi-like constriction 18′ in the form of a venturi tube 20′ arranged in the secondary duct 30. By arranging the venturi tube 20′ in proximity to the distributing element 22 the return duct 28 or the return ducts can be considerably shortened.

FIG. 9 shows a fifth embodiment of the present invention, in which the container 1 is divided into three compartments 30. A feed unit 24 in the form of a screw 24′ is arranged in each compartment 30. The screws 24′ in each compartment converge on and open into a common conveyor duct 2. FIG. 9 shows the container 1 from above. The part of the conveyor duct 2 at which the screws 24′ converge here consists of a rising pipe 32, which extends to a distributing element (not shown in FIG. 9). Different types of material such as seed, fertilizer and chemicals can be held in each compartment 30. A separate drive motor 34 can be connected to each screw 24′, so that these can rotate at different speeds. Before the material is led down into the ground the different types of material can be separated in special separators (not shown) in order to be placed on different levels in the ground. The container 1 may also be divided into a number of compartments 30 other than three.

FIG. 10 shows a sixth embodiment of the present invention, in which the container 1 is divided into two compartments 30 one behind the other. Two feed units 24 in the form of screws 24′ extend to a common conveyor duct 2. The part of the conveyor duct 2 at which the screws 24′ converge here consists of a rising pipe 32, which extends to a distributing element 22. One of the screws 24′ is longer than the other and extends from the one compartment 30 through the second compartment 30 and on to the rising pipe 32. In order that material placed in the second compartment will not be fed to the rising pipe 32 by the longer of the screws 24′, the part of the screw 24′ that extends through the second compartment 30 is at least partially enclosed by a tubular element 36. In FIG. 10 a section 38 of the said tubular element 36 is cut away for the sake of clarity. Outside the container 1 the screws 24′ extend through a lock in the form of two pipe sections 40. The said pipe sections 40 are connected at one end to the container 1 and at the other end to the rising pipe 32. An aperture 42 is arranged on the pipe sections 40 to permit monitoring of the material feed quantity, so that the arrangement can be calibrated.

FIG. 11 shows a seventh embodiment of the present invention, viewed from above. A feed unit 24 in the form of a screw 24′ extends to a conveyor duct 2, which downstream of the connection with the screw 24′ branches into two separate branch ducts 44 each leading to its own distributing element 22. An adjusting device in the form of a valve 46 is arranged in the conveyor duct 2 in order to permit control of the material fed to each distributing element 22 from the screw 24′. The valve 46 can therefore be set to a position such that one of the distributing elements 22 is shut off and the other distributing element 22 distributes all the material fed. In this position the material feed quantity is reduced by controlling the blower so that the air flow is reduced and/or the quantity of material fed by the feed unit 24 is reduced.

FIGS. 12 and 13 show an eighth embodiment of the invention. According to this embodiment the feed unit 24 comprises a first screw conveyor 60 and a second screw conveyor 61, which are arranged essentially parallel with one another. The first and second screws 60, 61 have different dimensions, so that material of one type can be fed by the first screw 60 and material of another type can be fed by the second screw 61. The first screw 60 is arranged above the second screw 61 in relation to a vertical plane and the first screw 60 has a larger dimension than the second screw 61. The first screw 60 has a larger outside diameter and greater pitch than the second screw 61. The screws 60, 61 feed the material 6 towards the venturi-like constriction 18 in the conveyor duct 2. When material of a relatively large grain size is to be spread, the first screw 60 is used and when material with a small grain size is to be spread the second screw 61 is used. Both screws 60, 61 are connected to a common conveyor duct 2. The screws 60, 61, as shown in FIGS. 12 and 13, are arranged in a recess 48 in the bottom of the container 1. The container 1 is therefore designed so that it at least partially encloses the screws 60, 61. It is possible, however, to arrange one of the screws 60, 61 at least partially in a tubular element (not shown). A lock section 40 is arranged between the container 1 and the conveyor duct 2, the screws 60, 61 extending through the lock section 40 and the lock section 40 essentially enclosing the screws 60, 61.

A shut-off device 62 is arranged in order to shut off the connection between the conveyor duct 2 and each screw 60, 61, so that material is prevented from reaching the conveyor duct 2. One problem that can occur is that the air flow in the conveyor duct 2 can entrain material even when the screws 60, 61 are at a standstill. In certain cases the spreading of material must be suspended, such as when the machine is to be turned round on a field that is to be sown. The shut-off device 62 is designed as a plate 63, which is displaceable in the conveyor duct 2 and provided with a plug 64, which extends in each screw. According to the embodiment shown the central shafts 65 of the screws 60,61 are hollow, which allows the plug 64 to extend in the screw. The plug 64 may be provided with a control unit 66 for the purpose of displacing the plug 64 and the plate 63 in the longitudinal direction of the screw. When the plate 63 is displaced towards each screw 60, 61, the connection between the conveyor duct 2 and each screw 60, 61 will be closed, so that material is prevented from reaching the conveyor duct 2. It is also possible to spring load the plates 63 in the direction of each screw 60, 61.

FIG. 14 shows a ninth embodiment of the invention, in which the plates 63 are spring-loaded in the direction of each screw 60, 61. According to this embodiment the plugs 64 extend through the wall of the conveyor duct 2. Springs 67 are arranged on the outside of the conveyor duct 2 in order to bias the plates 63 towards each screw 60, 61. FIG. 15 shows a perspective view of an arrangement according to the ninth embodiment.

FIG. 16 shows a tenth embodiment of the invention. A rotatable sleeve 50 is arranged around the venturi-like constriction 18. The sleeve 50 is provided with a hole 52, which in an open position is intended to be set so that a connection is established between the conveyor duct 2 and a tubular section 40 arranged around a screw 24′. In FIG. 16 the sleeve 50 is shown in a closed position, which means that material from the container 1 is prevented from reaching the conveyor duct 2, so that the spreading of material is interrupted. This shut-off arrangement represented by the sleeve 50 can be used, for example, when the agricultural machine 16 is to be turned round on a field. By temporarily shutting off the supply of material when turning, material can be saved. The rotation of the screw 24′ is preferably shut off at the same time as the sleeve 50 is brought into the closed position. As shown in FIG. 16, a power element 54, such as a hydraulic or pneumatic cylinder, can control the turning of the sleeve 50 between the open and closed position. As an alternative embodiment to the sleeve 50 shown, a sliding cover (not shown) can be arranged between the tubular section 40 shown in FIG. 16 and the conveyor duct 2.

It must be pointed out that the figures attached only show the invention in schematic form. Only one agricultural machine 16 has been touched upon in connection with the embodiments shown. It is, however, possible to fit the arrangement according to the invention to other types of machines, such as a road salt spreading machine.

1. An arrangement for spreading material, comprising at least one container (1) for holding the material (6) and having a conveyor duct (2), which is connected to the container (1) and is designed to accommodate an air flow for conveying the material (6) from the container (1) to at least one dispensing element (12), characterized in that the conveyor duct (2) is provided with a venturi-like constriction (18) and that the container (1) is connected to the conveyor duct (2) by the said constriction (18), so that the material (6) is fed from the container (1) to the conveyor duct (2) by means of the venturi effect.

2. The arrangement according to claim 1, characterized in that a feed unit (24) is arranged between the container (1) and the conveyor duct (2), the feed unit (24) feeding the material (6) towards the venturi-like constriction (18) in the conveyor duct (2).

3. The arrangement according to claim 2, characterized in that the feed unit (24) is designed as a dosing unit in order to feed a predetermined quantity of material (6) from the container 1.

4. The arrangement according to claim 3, characterized in that the feed unit (24) is adjustable so that the predetermined quantity of material (6) can be adjusted.

5. The arrangement according to one of the preceding claims, characterized in that the feed unit (24) comprises a rotary screw (24′).

6. The arrangement according to one of the preceding claims, characterized in that at least two conveyor ducts (2) are adapted to convey the material (6), that each conveyor duct (2) is provided with a venturi-like constriction (18) and that a container (1) is connected to each conveyor duct (2) by the venturi-like constriction (18) of each conveyor duct (2).

7. The arrangement according to one of the preceding claims, characterized in that the arrangement is adapted to an agricultural machine (16), in which the material (6) consists of seed, fertilizer or the like and that each dispensing element (12) comprises an implement for delivering the material (6) to the ground.

8. The arrangement according to claim 7, characterized in that downstream of the venturi-like constriction (18) the conveyor duct (2) opens into at least one distributing element (22), which distributes the material (6) to each dispensing element (12), from which distributing element (22) at least one return duct (28) for material (6) extends for returning a proportion of the material (6) to the air flow in the conveyor duct (2).

9. The arrangement according to claim 8, characterized in that the return duct (28) is connected to the conveyor duct (2).

10. The arrangement according to claim 9, characterized in that the return duct (28) is connected to the conveyor duct (2) by the venturi-like constriction (18) in the conveyor duct (2).

11. The arrangement according to claim 8, characterized in that a secondary duct (30) is connected to the conveyor duct (2) in order to divert a part of the air flow in the conveyor duct (2) to the secondary duct (30) and then to return this part of the air flow to the conveyor duct (2).

12. The arrangement according to claim 11, characterized in that the return duct (28) is connected to the secondary duct (30) by a venturi-like constriction (18′) arranged in the secondary duct (30).

13. The arrangement according to any of the preceding claims, characterized in that the container (1) includes a filling hatch (10) and that atmospheric pressure prevails in the container (1).

14. The arrangement according to claim 2, characterized in that the container (1) is divided into a plurality of compartments (30), preferably three compartments (30), and that a feed unit (24) is arranged in each compartment (30), so that each feed unit (24) is arranged to feed material to a common conveyor duct.

15. The arrangement according to claim 2, characterized in that a lock section (40) is arranged between the container (1) and the conveyor duct (2), through which lock section (40) the feed unit (24) extends and by means of which lock section (40) the material feed quantity can be monitored.

16. The arrangement according to claim 8, characterized in that at least two distributing elements (22) are arranged downstream of the venturi-like constriction (18) and that an adjusting device (46) is arranged in the conveyor duct (2) in order to distribute the quantity of material to each distributing element (22).

17. The arrangement according to claim 5, characterized in that two parallel screws (24′) of different dimensions are arranged in the container (1) so that material of one type can be spread by the one screw (24′) and material of another type can be spread by the second screw (24′).

18. The arrangement according to any of the preceding claims, characterized in that a rotatable sleeve (50), which is provided with a hole (52), is arranged in the venturi-like constriction, it being possible to adjust the sleeve (50) between an open position for spreading and a closed position.

19. An arrangement for spreading material, comprising at least one container (1) for holding the material (6), a conveyor duct (2) connected to the container (1) and designed to accommodate an air flow for conveying the material (6) from the container (1) to at least one dispensing element (12) and at least one feed unit (24) in the form of a screw conveyor (60, 61) for feeding the material from the container (1) to the conveyor duct (2), characterized in that the feed unit (24) comprises a first and second screw conveyor (60, 61), which are arranged essentially parallel with one another.

20. The arrangement according to claim 19, characterized in that the first and second screw (60, 61) have different dimensions, so that material of one type can be fed by the first screw (60) and material of another type can be fed by the second screw (61).

21. The arrangement according to any of claims 19 to 20, characterized in that the first screw (60) is arranged above the second screw (61) in relation to a vertical plane and that the first screw (60) has a larger dimension than the second screw (61).

22. The arrangement according to any of claims 19 to 21, characterized in that the first screw (60) has a larger outside diameter and greater pitch than the second screw (61).

23. The arrangement according to any of claims 19 to 22, characterized in that the container is designed so that it at least partially encloses the screws (60, 61).

24. The arrangement according to any of claims 19 to 23, characterized in that a lock section (40) is arranged between the container (1) and the conveyor duct (2), the screws (60, 61) extending through the lock section (40) and the lock section (40) essentially enclosing the screws (60, 61).

25. The arrangement according to any of claims 19 to 24, characterized in that the conveyor duct (2) is provided with a venturi-like constriction (18) and that the container (1) is connected to the conveyor duct (2) by the said constriction (18), so that the screws (60, 61) feed the material (6) in the direction towards the venturi-like constriction (18) in the conveyor duct (2).

26. The arrangement according to any of claims 19 to 25, characterized in that a shut-off device is arranged to shut off the connection between the conveyor duct (2) and each screw (60, 61), so that material is prevented from reaching the conveyor duct (2).

27. The arrangement according to any of claims 19 to 26, characterized in that the shut-off device is designed as a plate displaceable in the conveyor duct (2).
